(19) United States
(12) Patent Application Publication
(10) Pub. No.: US 2015/0296246 A1
(43) Pub. Date: Oct. 15, 2015

(54) AUDIO VISUAL INTERFACES

(71) Applicant: CAMELOT STRATEGIC SOLUTIONS LIMITED, Watford, Hertfordshire (GB)

(72) Inventors: Rupert Holt, Watford (GB); Alex Schajer, Watford (GB)

(73) Assignee: CAMELOT STRATEGIC SOLUTIONS LIMITED, Watford (GB)

(21) Appl. No.: 14/441,367

(22) PCT Filed: Nov. 11, 2013
(86) PCT No.: PCT/GB2013/052966

§ 371 Date: May 7, 2015

(30) Foreign Application Priority Data
Nov. 9, 2012 (GB) 1220224.8
Aug. 28, 2013 (GB) 1315308.5

(51) Int. Cl. H04N 21/43; H04N 21/81; H04N 21/462; H04N 21/41; H04N 21/439

(52) U.S. Cl. CPC H04N 21/4307; H04N 21/4126; H04N 21/4394; H04N 21/4622; H04N 21/8133; H04N 21/8173; H04N 21/8186

(57) ABSTRACT

The invention relates to a method and apparatus for coordinating a mobile communications device with a media broadcast. The invention comprises detecting on a mobile communications device a sub-audio signal transmitted in a media broadcast, receiving on the mobile communications device an event signal relating to an event in the media broadcast, wherein the event signal is provided with a time reference corresponding to the related event in the media broadcast, and executing on the mobile communications device content relating to the event in the media broadcast, wherein execution of the content is controlled according to the time reference corresponding to the event in the media broadcast and the sub-audio signal.

### FIELD OF INVENTION

The present invention concerns improvements to methods and apparatus for interacting with media broadcasts, for example, radio and television programmes. In particular, the invention relates to methods and apparatus for coordinating the output of a mobile communications device, such as a mobile telephone or tablet computer, with events occurring in a media broadcast.

### BACKGROUND OF THE INVENTION

It is known to encode data in the audio of a media broadcast. For example, International Patent Application Publication Number WO 01/10065 A1 discloses a method and apparatus for combining a data signal with an audio signal and transmitting the combined signal in a television broadcast. Examples of encoders for encoding a data signal with an audio signal are provided in International Patent Application Publication Number WO 02/45286 A2.

The encoders described in International Patent Application Publication Number WO 02/45286 A2 convert the data signal into a sub-audio signal that is carried within the audio signal of a television signal. In the context of the invention, “sub-audio” refers to acoustic signals outside the range of human hearing. Accordingly, sub-audio signals are typically virtually or totally inaudible to humans.

When the television broadcast of International Patent Application Publication Number WO 01/10065 A1 is received by a television, the combined signal is output through the television's loudspeakers as an audio signal. The audio signal is detected by a microphone incorporated in a toy which is arranged to respond to the sub-audio signal portion of the combined signal.

International Patent Application Publication Number WO 02/45273 A2 discloses systems in which a data signal is converted into a sub-audio signal, which is incorporated into the audio signal of a television broadcast. The audio signal is output through a television loudspeaker so that a sub-audio signal that corresponds to the data signal is detected by a mobile telephone which is arranged to recover data from the sub signal. The data may convey information that may be presented to the user, or the data may trigger an application, for example, a software application, stored on the mobile telephone.

Broadcasters using prior art systems to enable interaction with a media broadcast are unable to coordinate actions taking place on a mobile communications device with events occurring in the media broadcast. For example, if a sub-audio code triggers an application on a mobile communications device to obtain information via a further routing path, such as a mobile communications network or the Internet, it is not possible to coordinate the time of receipt and display of that information with events taking place in the broadcast.

This is because, in the case of a television programme, the television programme is simultaneously broadcast over a number of networks. In the UK for example, a television programme may be broadcast at the same time over a digital terrestrial television network such as Freeview®, a direct-broadcast satellite television network such as Sky® and a digital cable television network such as Virgin Media®. Since each network broadcasts the programme over a different routing path, the events taking place in the programme are not displayed synchronously by televisions receiving the programme via different networks. Therefore, it is not possible to coordinate data received via a further routing path with the television programme.

For example, the further routing path may deliver information, such as the identity of a murderer in a murder-mystery programme, the answer to a question in a game show or information relating to a ball drawn in a televised lottery draw, to a mobile communications device before or after that event is shown on a television set receiving a broadcast of that programme. Any lack of synchronicity between events taking place in the television programme and actions or events displayed on a mobile communications device will detract from the mobile communication device user's experience.

A problem for the makers of television programmes and broadcasters is how to improve interactivity between television viewers and television programmes. In particular, television programme makers are keen to improve how television viewers may receive further information during and with respect to television programmes as they are broadcast, for example, via the Internet and/or mobile communications networks.

In view of this, the present invention seeks to provide methods and apparatus to improve the experience of watching or listening to media broadcast while “playing along” with the media broadcast on a mobile communications device. In particular, one of the problems that the present invention seeks to overcome is the problem of lack of synchronicity between events taking place in a media broadcast and events taking place on a mobile communications device that are related to the events taking place in the media broadcast.

### BRIEF SUMMARY OF THE INVENTION

According to a first aspect, the invention resides in a method of coordinating a mobile communications device with a media broadcast. The method comprises detecting on a mobile communications device a sub-audio signal transmitted or broadcast in a media broadcast, receiving on the mobile communications device an event signal relating to an event in the media broadcast, wherein the event signal is provided with a time reference corresponding to the related event in the media broadcast, and executing on the mobile communications device content relating to the event in the media broadcast, wherein execution of the content is controlled according to the time reference corresponding to the event in the media broadcast and the sub-audio signal.

The invention ensures that content stored on the mobile communications device that relates to an event taking place in a media broadcast, regardless of whether the media broadcast is a live or recorded broadcast, is executed on the mobile communications device so that it is synchronised with that event. Advantageously, the invention ensures that the problems associated with content being executed on a mobile communications device before or after events corresponding to the content take place in the media broadcast are overcome. In particular, associating a time reference with an event in the media broadcast ensures that related content is executed in synchronisation with that event in the media broadcast. The media broadcast may be a television, radio or online broadcast.

The method may further comprise initiating on the mobile communications device a module arranged to receive the event signal. In a preferred embodiment of the invention, an application residing on the mobile communications device performs at least one or more of the steps of detecting the sub-audio signal, initiating the module for receiving an event signal and executing the content. The application may be downloadable to the mobile communications device.

The initiation step may be the result of a user of the mobile communications device manually initiating the module, or the mobile communications device automatically initialising the module on receipt of the sub-audio signal.

To ensure that the correct content is executed for an event taking place in the media broadcast, the event signal may contain information for identifying content relating to the event. Accordingly, in a preferred embodiment of the invention upon receipt of the event signal the content relating to the event in the media broadcast is executed on the mobile communications device according to the time reference. The information may comprise a code. The code may identify or relate to the event. The method may comprise a plurality of codes, wherein each code in the plurality of codes identifies or relates to a different event.

In a preferred embodiment, the method may comprise encoding or converting an event signal into the sub-audio signal. In a preferred embodiment, the event signal may comprise a data signal relating to the event. Preferably, the sub-audio signal may comprise the event signal. The sub-audio signal may relate to an event in the media broadcast. The time of receipt of the sub-audio signal may define the time reference of the event signal.

As mentioned above, the sub-audio signal is transmitted in a media broadcast, which means that it may be received by a plurality of mobile communications devices at different times due to the different length of times it takes different networks to transmit the media broadcast. The position of the sub-audio signal in the media broadcast may be preferably fixed in relation to events taking place in the media broadcast. Therefore, the time reference may be provided by combining the sub-audio signal with the media broadcast at a point in the media broadcast that corresponds to the event. In this way, the event signal is received by the mobile communications device as the corresponding event takes place in the media broadcast as it is displayed on a viewer's television or other transmission receiving apparatus.

Accordingly, the sub-audio signal itself may form the time reference. Since the time reference corresponds to the event in the media broadcast, the time reference ensures that the content is executed in synchronisation with the event regardless of the network on which the media broadcast is transmitted.

The overall effect is to coordinate the output of a plurality of mobile communications devices with events taking place in a media broadcast. This allows multiple televisions or other transmission receiving apparatus to receive the media broadcast, and generate the sub-audio signal from the media broadcast. Therefore, each member of a plurality of viewers is able to enjoy content on their mobile communications devices, wherein the content relates to events taking place in the media broadcast. Each of their mobile communications devices execute content relating to the events, as those events occur in the media broadcast displayed on their transmission receiving apparatus.

The content may be stored on the mobile communications device, or in an application or store in the mobile communications device. The content may include media, text or application files that are played on the mobile communication device, or graphics that may be displayed on a display screen of the mobile communications device.

The method may comprise establishing a data connection between the mobile communications device and a server. Preferably, the data connection may be a secure web socket connection. Utilising a secure web socket connection is advantageous because the mobile communications device or the application is effectively ‘listening’ for further event signals which may be transmitted to the mobile communications device. The mobile communications device or application may respond to each event signal by executing the appropriate content for that event.

The overall effect is far more efficient than traditional data connections because utilising a secure web socket connection removes the need for a mobile communications device or an application residing on the mobile communications device to check to see if there have been any further events. This is because traditional methods of communication require the mobile communications device or application to send one or more messages to a server to find out if any events have taken place, and then receive a response for each event. For example, to receive information in respect of six events, a traditional mobile communications device or application needs to complete a minimum of twelve transaction calls across a data communications network to a server, and more if no response is received to a message and the message must be resent. The mobile communications device or application according to the invention may simply receive the data signals relating to events in the media transmission.

The event signal may be transmitted over the data connection. In a preferred embodiment, the data connection may be initialised upon receipt of the sub-audio signal by the mobile telecommunications device. Preferably, the event signal may be a data signal transmitted via the data connection. Advantageously, the event signal may be received by the mobile communications device via the data connection as the corresponding event takes place in the media transmission. Preferably, the data connection is a wireless data connection.

Preferably, the data signal or event signal may contain the time reference. The time reference preferably controls when the content relating to the event is to be executed on the mobile communications device. The time reference may be measured with reference to the sub-audio signal. Preferably, the content on the mobile communications device may be executed at a set time after receipt of the sub-audio signal. Advantageously, the time reference in the event signal prevents content from being executed out of synchronisation with the event taking place in the media broadcast. The time reference may indicate how long after receipt of the sub-audio signal by the mobile communications device the content relating to the event is to be executed.

By adding a time reference to the data signal or an event signal that relates to the point in the media broadcast that the content relates to, it is possible to overcome the problem in the prior art of content being executed before that event is shown on receiving apparatus such as a television. This is because execution of the content is delayed until the point in the media broadcast is received and shown on the receiving apparatus.

The method may further comprise receiving at least one additional event signal as described above at the mobile communications device. Preferably, each of the at least one additional event signals relates to an additional event in the media broadcast, and each of the at least one additional event signals may have a time reference as described above in relation to the at least one additional event. The method may also comprise executing content relating to the at least one additional event on the mobile communications device according to the time reference of the additional event. Advantageously, the invention enables a mobile communications device to execute content in response to multiple events in the media broadcast. The content executed by the mobile communications device may vary according to the event taking place in the media broadcast. In this embodiment, the time reference may include details of the intervals between each event to control when the content relating to each event is executed. Alternatively or in combination, the time reference may be measured with reference to a sub-audio signal.

According to a further embodiment of the invention, the method may further comprise entering information or data relating to the event into the mobile communications device. Preferably, events taking place in the media broadcast may be compared with the entered information or data, which may trigger an action or content on the mobile communications device. Preferably, the method may comprise matching the event information or data with the event signal, and the content may be linked to the event information or data.

The method may further comprise downloading content and/or event signals relating to the event to the mobile communications device. For example, all or part of the event signals relating to events in a media broadcast may be downloaded to the mobile communications device. In addition, content relating to those events may be downloaded to the mobile communications device.

According to a second aspect, the invention resides in an application for coordinating content executed on a mobile communications device with a media broadcast, the application comprising an analysis module for analysing the audio component of a media broadcast for a sub-audio signal, a communications module arranged to receive an event signal relating to an event in the media broadcast, wherein the event signal has a time reference that relates to the event, and a store of content wherein the content relates to events in the media broadcast, wherein the application is arranged to execute content relating to the event in the media broadcast in accordance with the time reference and the sub-audio signal.

The application may also comprise an interface for manually entering information or data relating to the event into the store of the application. Preferably, the application may be arranged to match the manually entered information or data on receipt of the event signal to the event in the media broadcast.

Preferably, the time reference may be provided by combining the sub-audio signal with the media broadcast at a point in the media broadcast that corresponds to the event. In this way, the event signal is received by the application as the corresponding event takes place in the media broadcast. In response to the event signal, the application may be arranged to coordinate the audio and/or visual output of the mobile communications device with events occurring in the media broadcast. The application may be arranged to trigger at least one function or action on a mobile communications device relating to the content upon detection of the event signal relating to the event.

In a further embodiment of the invention, the application may further comprise a data communications module for communicating with a server over a data network, wherein the data communications module is arranged to receive one or more data signals. Each of the one or more data signals may be an event signal according to the invention. Preferably, each data signal may contain the time reference which controls when the content relating to the event is to be executed on the mobile communications device. Preferably, the application may be arranged to communicate with the server using a web socket protocol.

Preferably, the application may further comprise a controller for executing the content on a mobile communications device on receipt of the event signal. The content may comprise one or more of media, text or application software files.

According to a third aspect, the invention also extends to a mobile communications device, such as a tablet computer or a mobile telephone, comprising an application having one or more of the features described above.

According to a fourth aspect, the invention also extends to a system for coordinating content on a mobile communications device with a media broadcast. The system may comprise a server for processing an event signal relating to an event in the media broadcast, and an encoder for combining a sub-audio signal with a media broadcast to form a combined signal. The combined signal may be a composite signal. Preferably, the system is arranged to add a time reference to the event signal corresponding to the related event in the media broadcast.

The system may comprise receiving apparatus arranged to receive the composite signal, the receiving apparatus comprising a speaker to generate the audio portion of the combined signal. Examples of the receiving apparatus include a television, a radio or computing equipment arranged to receive a media broadcast via the Internet. The receiving apparatus may be arranged so that the sub-audio signal is detectable when the audio portion of the combined signal is generated in an acoustic signal by the receiving apparatus.

The encoder may be arranged to convert the event signal into the sub-audio signal. Alternatively or in addition, the encoder may be arranged to convert a data signal into the sub-audio signal

In a preferred embodiment, the system further comprises transmission apparatus for transmitting the combined signal.

The system may further comprise a mobile communications device arranged to coordinate its audio and/or visual output with the media broadcast on detection of the sub-audio signal. The mobile communications device may comprise a software application arranged to analyse the audio portion of the combined signal for the sub-audio signal. The mobile communications device or software application may further comprise content relating to the event, wherein the mobile communications device is arranged to execute the content in accordance with the time reference.

The invention provides a new communication channel between a media viewer and the media provider. This new communication channel may be used in a number of new ways, such as notification of new media broadcasts or games that may be played along with a media broadcast. Information may be provided in retail locations that may be used to provide details to media viewers on how to access this new communications channel.

The invention overall provides a more interactive user experience at home or anywhere where a sub-audio code may be broadcast and/or received by a mobile communications device.

### BRIEF DESCRIPTION OF THE DRAWINGS

Presently preferred embodiments of the invention will be described, by way example only, with reference to the following drawings, in which:

FIG. 1 is a schematic diagram of a system enabling a user to interact with a television program according to the invention;

FIG. 2 is a schematic diagram illustrating the components associated with a server according to the invention;

FIG. 3 is a schematic diagram illustrating the components of a mobile communications device and an application installed on the device according to the invention;

FIG. 4 is a schematic diagram illustrating the equipment located in a television studio according to the invention;

FIG. 5a is a flow diagram illustrating a method of interacting with a media broadcast according to a first embodiment of the invention;

FIG. 5b is a message signal diagram illustrating the message flow between various parts of the system according to the first embodiment of the invention;

FIGS. 6 to 9 are schematic diagrams which illustrate the interaction between a mobile communications device and a media broadcast according to the invention;

FIG. 10a is a flow diagram illustrating a method of interacting with a media broadcast according to an alternative embodiment of the invention; and

FIG. 10b is a message signal diagram illustrating the message flow between various parts of the system according an alternative embodiment of the invention.

### DETAILED DESCRIPTION OF THE INVENTION

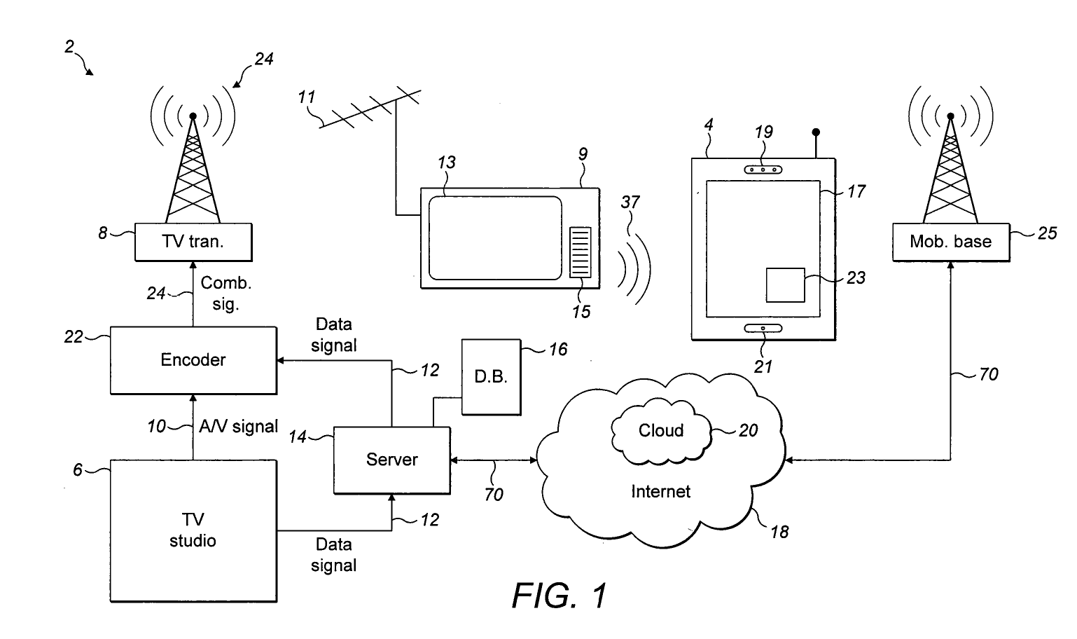

An interactive media broadcast system 2 for coordinating content on a mobile communications device (MCD) 4 with events taking place a media broadcast 10 according to the invention is described with reference to FIG. 1. The mobile communications device 4 comprises a display screen 17, a speaker 19, a microphone 21 and an application 23 (a software application). The mobile communications device 4 is linked to a mobile communications network indicated by a mobile base station 25.

The system 2 includes a television studio 6 in which a television programme is recorded for transmission at a later date, or broadcast live, over various transmission networks, such as a digital terrestrial television network, a direct-broadcast satellite television network and a digital cable television network. In the embodiments described below, the broadcast is transmitted across an entire country, for example the UK. However, the broadcast may be transmitted over smaller or larger territories or geographical areas, as required. For simplicity, FIG. 1 refers only to a digital terrestrial television network which transmits the media broadcast signal 10 via a television transmitter 8 to a television 9. The television 9 includes a television aerial 11, a television screen 13 and a loudspeaker 15. The television 9 receives the media broadcast signal 10 via the television aerial 11.

The television studio 6 generates the media broadcast signal (A/V signal) 10. The media broadcast signal 10 comprises an audio signal component and a visual signal component. Events occurring in the television studio 6 are each assigned an event signal which is a data signal 12 in the specific embodiments described herein. As described in more detail below, the system 2 is arranged to add a time reference to the event signal corresponding to the related event in the media broadcast 10.

The data signals 12 are fed to a server 14 for processing the event signals relating to the events in the media broadcast 10. The server 14 is linked to a database 16 that contains details of subscribers to the interactive service. The server 14 is arranged so that it may transmit data via the Internet 18. A cloud service 20 resides in the Internet 18. Depending on the form of the data signals 12 received by the server 14, the data signals 12 may be recorded in the database 16 and/or acted on by the server 14.

According to a first embodiment, the server 14 is arranged to forward the data signals 12 to an encoder 22 which converts the data signals 12 into sub-audio signals 64. The encoder 22 combines the sub-audio signals 64 with the media broadcast (A/V signal) 10 received from the television studio 6 to form a combined media broadcast signal 24 which comprises the media broadcast 10 and the sub-audio signals 64. In other embodiments of the invention, such as the alternative embodiment described below, a sub-audio signal may comprise other information, such as an alert signal, and the data signals 12 may follow an alternative routing path.

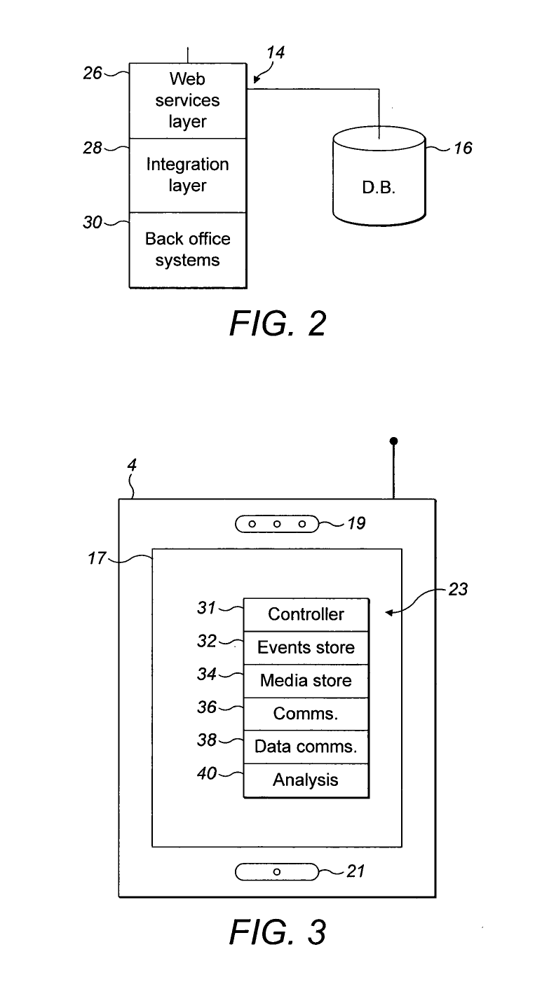

The server 14 is illustrated in more detail in FIG. 2. The server 14 comprises a web services layer 26 to handle communication between the server 14 and the Internet 18, an integration layer 28 which routes data to and from a media provider and back office systems 30 which enable the administration of the media provider's systems. The database 16 is shown linked to the server 14.

The television 9 receives television transmissions via the television aerial 11. The television 9 outputs the visual component of the combined media broadcast signal 24 on the television screen 13, and outputs the audio component of the combined media broadcast signal 24 via the loudspeaker 15. The loudspeaker 15 converts the audio component of the combined media broadcast signal 24 into an acoustic signal which includes the sub-audio signal 64.

The mobile communications device 4 may be a tablet computer, such as an Apple iPad® or Samsung Galaxy Note 10.1®, or a mobile telephone, such as an Apple iPhone® or Samsung Galaxy S4®. The mobile communications device 4 is arranged to communicate with the mobile base station 25. The mobile communications network is connected to the Internet 18. Accordingly, the mobile communications device 4 may communicate with the server 14 via the mobile communications network and/or the Internet 18.

FIG. 3 shows the components of the application 23 in more detail. The application 23 is arranged to coordinate content executed on the mobile communications device 4 with events taking place in the media broadcast 10. The application 23 contains an events store 32 into which a user of the mobile communications device 4 may enter data relating to events that take place in a media broadcast 10. For example, the user of the mobile communications device 4 may type data relating to events into the mobile communications deice 4 using a keypad associated with the device, whereby the data is stored in the events store 32. Alternatively, the user may scan an optical code such as a barcode or QR-code related to the events which results in data being stored in the events store 32, or cause the device 4 to download data relating to the events to the events store 32.

The application 23 also contains a media store 34 which is a store of content that relates to events that take place in the media broadcast 10. A controller 31 interfaces with the components of the mobile communications device 4 that operate the display screen and speaker 19 to execute the content on the mobile communications device 4. A communications module 36 is arranged to receive event signals relating to events that take place in the media broadcast 10. The application also comprises a data communications module 38 that enables the application to communicate with the server 14 via the mobile communications network and/or the Internet 18 via a data connection 70.

The application 23 also comprises an analysis module 40 for analysing the audio component of the combined media broadcast signal 24 for sub-audio signals 64. In particular, the analysis module 40 is arranged to analyse acoustic signals for sub-audio signals 64. As described below, the application 23 is arranged to execute content stored in the media store 34 relating to the events in the media broadcast 10 in accordance with the time reference.

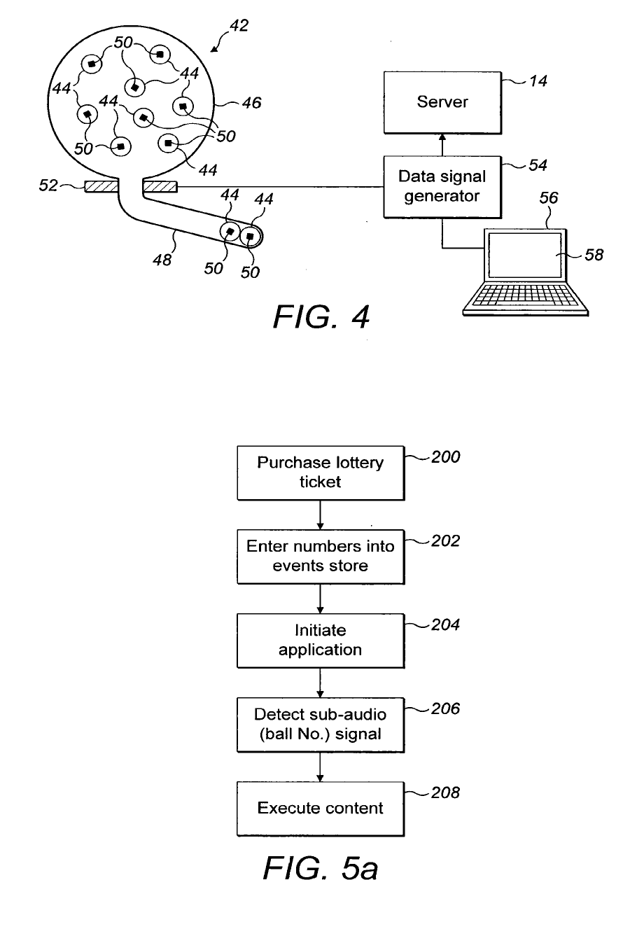

FIG. 4 illustrates equipment found in the television studio 6 shown in FIG. 1. The invention is described herein with reference to a television broadcast of a lottery draw administered by a lottery operator. However, it will be clear to the skilled person that the invention may be used to interact with other types of television programmes.

Selection apparatus is used to select an article from a set of articles, each article is unique to the set of articles and each article has its own identity. In the context of a lottery draw, as shown in FIG. 4, the selection apparatus is a lottery draw machine 42 and the set of articles is a set of individually numbered and unique lottery balls 44. The lottery draw machine 42 is located in the television studio 6. The lottery draw machine 40 contains the set of lottery balls 44, wherein each lottery ball 44 in the set is uniquely identifiable from the other balls in the set by a number. The lottery draw machine 42 comprises a main chamber 46 in which the balls 44 are randomly circulated. A ball drawing mechanism (not shown) draws balls 44 one at a time from the main chamber 46. Each drawn ball 44 from the main chamber 46 is collected in a draw tube 48.

To enable quick identification of each lottery ball 44, each lottery ball 44 has an identification (ID) transponder in the form of a radio frequency identification (RFID) device 50 that corresponds to the number of that ball 44. A detector in the form of an RFID receiver 52 surrounds the entrance to the draw tube 48 so that each ball 44 is detected and identified by the RFID receiver 52 as it is drawn and passes into the draw tube 48. As each drawn ball 44 passes by the RFID receiver 52, the RFID receiver 52 detects the drawn ball 44 and transmits a ball number signal 60 corresponding to the drawn ball 44 to a data signal generator (DSG) 54.

The data signal generator 54 is linked to the server 14, and is arranged to convert ball number signals 60 into data signals 12 which are transmitted to the server 14 which is external to the television studio 6. A studio computer 56 is linked to the data signal generator 54 which is arranged to display information relating to the received RFID receiver 52 ball number signals 60 on a studio computer screen 58.

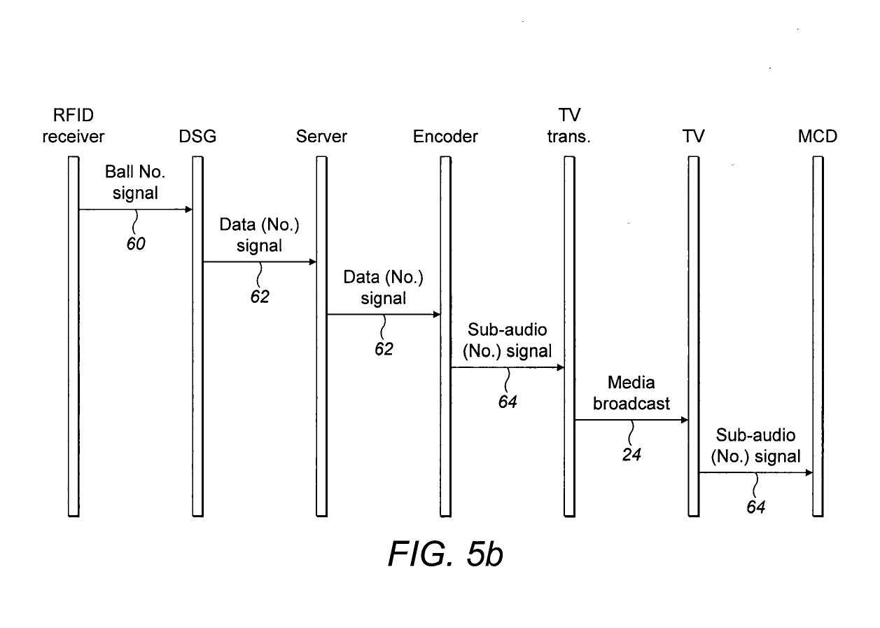

A method of interacting with the media broadcast 24 so that the mobile communications device 4 is coordinated with an event taking place in the media broadcast 10 according to the invention is described below with reference to FIG. 5a.

In order to enable a television viewer to interact with the television broadcast of the lottery draw, the viewer purchases a lottery ticket at Step 200 prior to the lottery draw. The viewer then enters the numbers of their lottery ticket at Step 202 into the events store 32 of the application 23 on the mobile communications device 4 by typing in the numbers of their lottery ticket using a keypad (not shown) associated with the mobile communications device 4.

In the specific embodiments described herein the viewer has purchased a lottery ticket comprising one set of numbers, i.e. 6, 15, 24, 29, 32, 46, which they enter into the events store 32. However, in another embodiment of the invention the viewer may buy a lottery ticket comprising several sets of lottery numbers which may be entered into the events store 32.

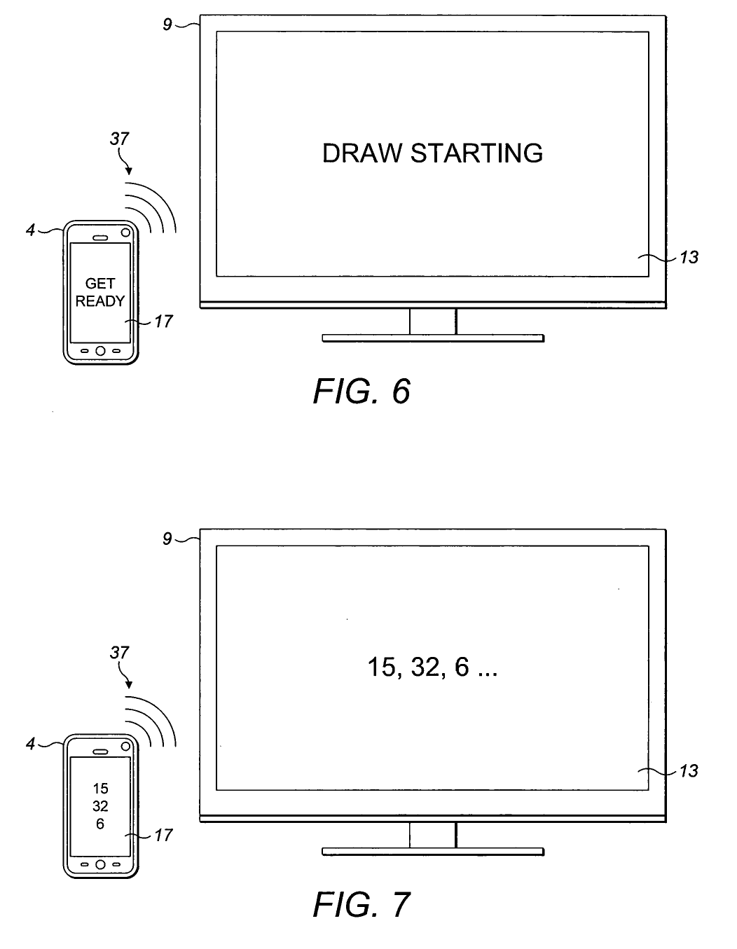

In order to interact with the broadcast of the lottery draw, the viewer initiates at Step 204 on the mobile communications device 4 the application 23 so that the communications module 36 is ready to receive one or more event signals. The viewer switches on the television 9 and watches the lottery draw on the television 9 with the mobile communications device 4 within range of an acoustic signal 37 generated by the loudspeaker 15 from the audio component of the combined media broadcast signal 24. FIG. 6 illustrates the mobile communications device 4 in close proximity to the television 9 as the lottery draw starts.

Once the lottery draw commences, balls 44 are drawn randomly from the main chamber 46, pass the RFID receiver 52 and collect in the draw tube 48. As each ball 44 passes the RFID receiver 52 the number of the ball 44 is received at the RFID receiver 52 from the corresponding RFID device 50. The RFID receiver 52 transmits each ball number to the data signal generator 54. The identity of each ball 44 may be transmitted from the RFID receiver 52 to the data signal generator 54 by wired or wireless transmission.

The system 2 comprises additional verification means for verifying the identity of each ball 44. In the presently described embodiment of the invention, the number of the ball 44 that has most recently passed the RFID receiver 52 appears on the studio computer screen 58 which is linked to the data signal generator 54. This allows an independent verifier to visually verify the balls 44 being drawn by the draw machine 42. This will be well known to the skilled person as a typical method for authenticating lottery draw processes around the world.

Once the number of a drawn ball 44 has been confirmed by the authenticator, the data signal generator 54 converts the RFID signal 60 into a data signal 62. A further check is performed to verify the number of the drawn ball 44 by sending the data signal 12 to computers in the television studio that control the media broadcast (A/V signal) 10 for the draw. If the data signal 12 matches the number of the drawn ball 44 as shown in the broadcast feed, staff in the television studio forward the data signal 12 to the server 14.

The server 14 forwards the data signal 12 to the encoder 22 which converts the data signal 12 into a sub-audio signal 64 that is combined in real time with the audio portion of the media broadcast 10 signal to form the combined media broadcast signal 24. The sub-audio signal 64 contains a number code that identifies the number of the drawn ball 44. The combined media broadcast signal 10 is broadcast by the television transmitter 8.

In particular, the audio segment of the media broadcast 10 used to callout the number of the ball 44 that has just been drawn (typically a pre-recorded sound-bite) is modified to include the sub-audio signal 64 corresponding to the number of the drawn ball 44.

The above steps occur in real time and there is virtually no discernible delay in the media broadcast 10 feed between detection of the drawn ball 44 by the RFID receiver 52 and the additional sub-audio signal 64 being merged with the media broadcast 10, and the transmission of the combined media broadcast signal 24 by the television transmitter 8.

The combined media broadcast signal 24 is received by the television 9 via the television aerial 11, and the audio portion of the combined media broadcast signal 24 is played by the loudspeaker 15. The analysis module 40 in the application 23 on the mobile communication device 4 monitors the acoustic signal 37 generated by the loudspeaker 15, and analyses the acoustic signal 37 to identify the sub-audio signal 64 encoding elements being broadcast during the lottery draw show.

FIG. 7 illustrates the drawing of the first three balls 44 in the lottery draw on the television 9. The first ball 44 drawn is the ball numbered “15”; the second ball 44 drawn is the ball numbered “32”; and the third ball 44 drawn is the ball numbered “6”. FIG. 7 also shows the display screen 17 of the mobile communications device 4 on which the number of each drawn ball 44 appears as it is drawn and appears in the media broadcast 10 of the lottery draw shown on the television screen 13.

As the 15-ball passes the RFID receiver 52, the 15-ball's RFID device 50 transmits a signal indicating that the 15-ball has passed the RFID receiver 52. As shown in FIG. 5b, the RFID receiver 52 forwards the 15-ball signal 60 to the data signal generator 54 which forwards it onto the server 14 as a data signal 62 that identifies the ball numbered “15”. In turn, the server 14 forwards the data signal 62 to the encoder 22.

The encoder 22 converts the data signal 62 into a sub-audio signal 64 relating to the 15-ball and combines the 15-ball sub-audio signal 64 with the audio portion of the media broadcast 10. The combination of media broadcast 10 signal and sub-audio signal 64 occurs at a point in the audio portion of the media broadcast 10 signal relating to the drawing of the 15-ball. Thus the sub-audio signal 64 is an event signal which provides a time reference corresponding to the related event in the media broadcast 10. The television transmitter 8 transmits the combined media broadcast signal 24 in which the sub-audio signal 64 is embedded.

The combined media broadcast signal 24 is received by the television 9 which plays the audio portion of the combined media broadcast signal 24, which includes the 15-ball sub-audio signal 64, through the loudspeaker 15 which generates an acoustic signal 37 corresponding to the audio portion of the combined media broadcast signal 24.

The microphone 21 on the mobile communications device 4 detects the acoustic signal 37 generated by the loudspeaker 15 from the audio portion of the combined media broadcast signal 24. At Step 206 the application 23 on the mobile communications device 4 detects the 15-ball sub-audio signal 64 transmitted in the audio signal of the combined media broadcast signal 24. In this embodiment of the invention, the sub-audio signal 64 is the event signal. Accordingly, the 15-ball sub-audio signal 64 relates to the event in the media broadcast 10 of the drawing of the 15-ball in the lottery draw.

Receipt by the mobile communications device 4 of the sub-audio signal 64 relating to the drawing of the 15-ball in the media broadcast 10 triggers the application 23 on the mobile communications 4 device at Step 208 to execute content relating to the drawing of the 15 ball. In the present embodiment of the invention, the content comprises image files, wherein each image file corresponds to the number of a ball 44 that may be drawn in the lottery. Accordingly, as the 15-ball is drawn the number “15” appears on the display screen 17 of the mobile communications device 4.

Since the sub-audio signal 64 is added to the media broadcast 10 at a point in the media broadcast 10 corresponding to the event associated with the sub-audio signal 64, and the application 23 is arranged to execute content stored in the media store 34 upon receipt of the sub-audio signal 64, execution of the content on the mobile communications device 4 occurs when the television 9 shows the 15-ball being drawn from the main chamber 46.

As each further ball 44 is drawn a corresponding sub-audio signal 64 relating to that ball 44 is generated and combined with the media broadcast 10 to form a combined media broadcast signal 24. Accordingly, when the television 9 shows the 32-ball being drawn, a sub-audio signal 64 that identifies the 32-ball is detected by the application 23 which triggers the number “32” to appear on the display screen 17 of the mobile communications device 4. Similarly, when the television 9 shows the 6-ball being drawn, a sub-audio signal 64 that identifies the 6-ball is detected by the application 23 which triggers the number “6” to appear on the display screen 17 of the mobile communications device 4.

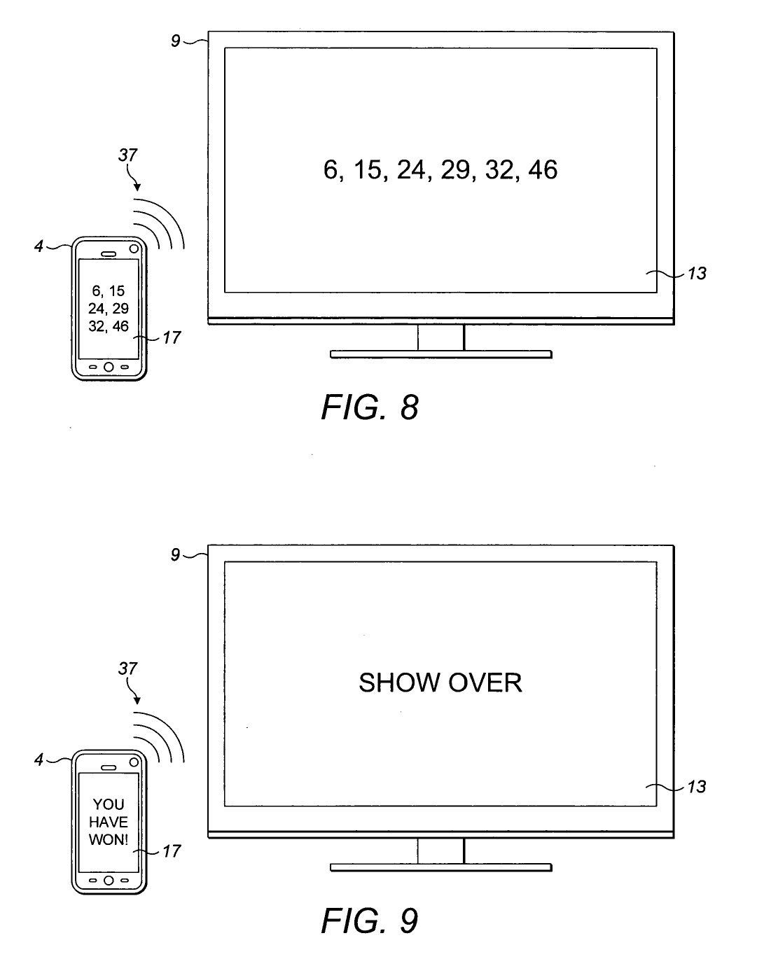

As shown in FIG. 8, the remaining balls 44 drawn in the lottery draw are the ball numbers “24”, “29” and “46”. Similarly to the 32-ball and the 6-ball described above, the drawing of each of the remaining balls 44, i.e. the 24-ball, 29-ball and the 46-ball, in the lottery draw results in the generation of a sub-audio signal 64 relating to that ball 44. Each sub-audio signal 64 is added to the audio signal of the media broadcast 10 at the point in the media broadcast 10 when the respective subsequent ball 44 is drawn. The application 23 on the mobile telecommunications device 4 responds to each sub-audio signal 64 by displaying the corresponding number on the display screen 17 of the mobile communications device 4, as set out above.

As is customary, once the final ball 44 has been drawn the numbers relating to the drawn balls 44 are displayed in numerical order on the display screen 17 of the mobile communications device 4 and the television screen 13.

In an alternative embodiment of the invention (not shown), the display screen 17 of the mobile communications device 4 displays the numbers of the lottery ticket entered by the viewer at Step 202 into the events store 32 of the application 23. When a matching ball 44 is drawn in the lottery draw, the corresponding number displayed on the display screen 17 is highlighted as each respective sub-audio signal 64 is detected by the mobile communications device 4. Accordingly, as each ball 44 is drawn by the lottery draw machine 42, the corresponding numbers on the display screen 17 of the mobile communications device 4 become highlighted one number at a time.

The appearance or highlighting of numbers or icons relating to drawn balls as each ball is drawn gives the effect that each ball is also being “drawn” on the mobile communications device 4 at the same time as in the media broadcast 10 received by the television 9.

If the drawn balls 44 relate to a winning set of numbers the application 23 notifies the viewer that they have won by displaying the message “YOU HAVE WON!” on the display screen 17 of the mobile communications device 4, as shown in FIG. 9.

The invention provides an appealing visual sequence effect on the display screen 17 of the mobile communications device 17 and enhances the player's enjoyment of the lottery draw. In effect, the application 23 ‘hears’ the sub-audio signals 64 and then highlights or displays the appropriate ball number on the display screen 17 of the mobile communications device 4 as part of the lottery draw process. In a further alternative embodiment, an animation relating to the drawn ball 44 is played on the display screen 17 of the mobile communications device 4 as the ball 44 is drawn in the media broadcast 10.

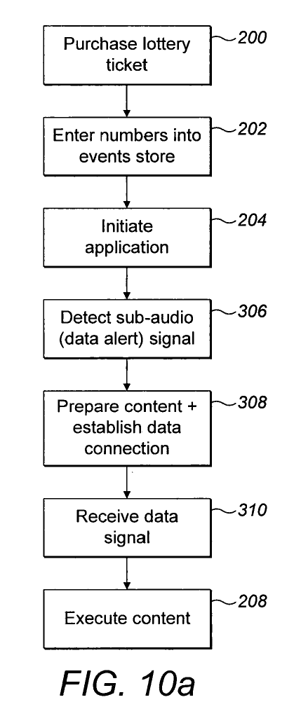

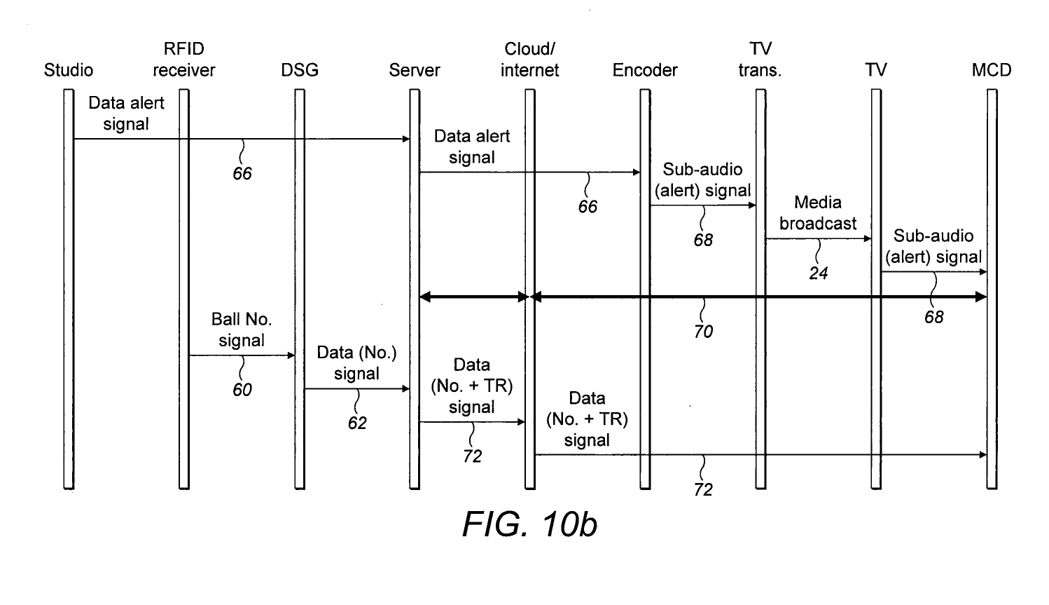

In an alternative embodiment of the invention, described with reference to FIGS. 10a and 10b, rather than the application 23 on the mobile communications device 4 monitoring the audio component of the combined media broadcast 34 for sub-audio signals 64 that relate to each drawn ball 44, the application 23 on the mobile communications device 4 communicates with the server 14 via the mobile communications network 25 and the Internet 18 to obtain information regarding the drawn balls 44.

Features of the invention and steps of the method of the invention of the alternative embodiment that are identical to those of the first embodiment of the invention have been given the same reference numerals in the figures.

In order to interact with a media broadcast 10 in accordance with the alternative embodiment of the invention, the television viewer purchases a lottery ticket at Step 200 prior to the lottery draw in the same way as in the first embodiment of the invention described above.

Again, in the same way as in the first embodiment, the viewer then enters the numbers of their lottery ticket at Step 202 into the events store 32 of the application 23 on the mobile communications device 4. For simplicity, in the description of the alternative embodiment the viewer enters the same numbers as in the first embodiment described above, i.e. 6, 15, 24, 29, 32, 46. However, in another embodiment of the invention the viewer may buy a lottery ticket comprising several sets of lottery numbers. Once the viewer has entered their lottery numbers into the events store 32, the viewer initiates the application 23 on the mobile communications device 4 at Step 204 before the lottery draw commences.

Before the first ball 44 is drawn in the lottery draw the studio computer 56 sends a single data alert signal 66, shown in FIG. 10b, to the server 14 at a pre-determined time before the first ball 44 is drawn. Referring to FIG. 6, the single data alert signal 66 is sent to the server 14 at a point when the lottery draw is starting in the television studio 6. The server 14 sends the data alert signal 66 to the encoder 22 which converts the data alert signal 66 into a sub-audio alert signal 68. The sub-audio alert signal 68 contains information relating to the draw, including the time and date of the draw. The encoder 22 also combines the sub-audio alert signal 68 with the audio component of the media broadcast 10 as described in the previous embodiment of the invention. The combined media broadcast signal 24 is then broadcast by the television transmitter 8.

The combined media broadcast signal 24 is received by the television 9 and the audio portion of the combined media broadcast signal 24 is played by the loudspeaker 15. The single sub-audio alert signal 68 is detected by the application 23 on the mobile communications device 4 at Step 306. Receipt of the sub-audio alert signal 68 triggers the application 23 at Step 308 to prepare for the lottery draw sequence and prepare the content stored in the media store 34 for execution in synchronisation with the media broadcast 10. The sub-audio alert signal 68 also prompts the application 23 at Step 308 to establish the data connection 70 between the mobile communications device 4 and the server 14 via the Internet 18.

The data connection 70 between the mobile communications device 4 and the server 14 is in the form of a secure web socket service, for example, a HTML5 service, with a broadcast cloud 20 service utilised by the broadcaster of the lottery draw and/or the lottery operator. A web socket service on HTML5 enables a cloud service, which may be provided by a third party, to set up a live secure connection to the mobile communications device 4. The cloud service is arranged to set up data connections with a plurality of mobile communications devices 4.

As illustrated in FIG. 7, the first ball 44 drawn in the draw is the ball numbered “15”. As the 15-ball passes the RFID receiver 52 its RFID device 50 transmits its identity to the RFID receiver 52. The RFID receiver 52 forwards the 15-ball signal 60 to the data signal generator 54. The data signal generator 54 generates a data signal 62 relating to the 15-ball. The 15-ball data signal 62 is sent to the server 14. The server 14 adds a time reference (TR) to the data signal 62 to form a modified data signal 72 which indicates how long after receipt of the sub-audio data alert signal 68 content stored in the media store 34 should be displayed on the display screen 17 of the mobile communications device 4.

The server 14 forwards the modified data signal 72 to the cloud service 20 which broadcasts the modified 15-ball data signal 72 to the mobile communications device 4 via the Internet 18. As an additional verification step, the number of the drawn ball 44 is visually confirmed by an authenticator before the modified data signal 62 is released to the cloud network 20 service for broadcasting to the mobile communications device 4. The modified 15-ball data signal 72 is received by the mobile communications device 4 at Step 310.

Receipt of modified 15-ball data signal 72 by the mobile communications device 4 triggers the application 23 at Step 208 to execute content stored in the media store 34 relating to the 15-ball at a time after receipt of the sub-audio alert signal 68 which relates to the drawing of the ball 44 in the media broadcast 10. If the modified data signal 72 is received by the mobile communications device 4 before the time after receipt of the sub-audio alert signal 68 designated by the time reference (TR), the application 23 will delay playing the associated content until that time.

In the present embodiment of the invention, the content comprises image files, wherein each image file corresponds to the number of a ball 44 that may be drawn in the lottery. Accordingly, as the 15-ball is drawn in the media broadcast 10 the application 23 ensures that the number “15” appears on the display screen 17 of the mobile communications device 4.

Since the modified data signal 72 has a time reference (TR) relating to a time subsequent to the sub-audio alter signal 68, and the application 23 is arranged to execute content stored in the media store 34 in accordance with the time reference (TR), execution of the content on the mobile communications device 4 occurs when the television 9 shows the 15-ball being drawn from the main chamber 46.

As each further ball 44 is drawn by the draw machine 42, it passes the RFID receiver 52. The RFID device 50 associated with each further ball 44 which transmits the number of the ball 44 to the RFID receiver 52. The RFID receiver 52 forwards the ball number signal 60 to the data signal generator 54. The data signal generator 54 generates a data signal 62 relating to the drawn ball 44. The data signal 62 is sent to the server 14 which adds a time reference (TR) relating to the time of drawing of each further ball 44 after receipt of the sub-audio alert signal 68.

Therefore, when the television 9 shows the 32-ball being drawn, a modified data signal 72 that identifies the 32-ball and the time it is drawn after the sub-audio alert signal 68 is sent via the data connection 70 to the mobile communications device 4. Upon receipt of the modified 32-ball data signal the application 23 triggers the number “32” to appear on the display screen 17 of the mobile communications device 4 in accordance with the time reference (TR). Similarly, when the television 9 shows the 6-ball being drawn, a modified 6-ball data signal 72 is sent to the mobile communications device 4 which triggers the number “6” to appear on the display screen 17 of the mobile communications device 4.

As shown in FIG. 8, the remaining balls 44 drawn in the lottery draw are the ball numbers “24”, “29” and “46”. Modified data signals 72 are generated and sent to the mobile communications device 4 for each of the remaining balls 44. The application 23 executes content relating to each of the remaining balls 44, which is displayed on the display screen 17 of the mobile communications device 4, as set out above. As in the first embodiment described above, once the final ball 44 has been drawn the numbers relating to the drawn balls 44 are displayed on the display screen 17 of the mobile communications device 4 and the television screen 13.

The alternative embodiment of the invention enables the application 23 on the mobile communications device 4 to execute content stored in the media store 34 relating to a drawn ball 44 when the drawing of that ball 44 is shown in the media broadcast 10 on the television 9. In particular, the alternative embodiment ensures that if a data signal 72 relating to a drawn ball 44 is received before the drawing of the ball 44 is shown on the television 9, the execution of the content is delayed until the point in the media broadcast 10 that relates to the drawing of that ball 44 is shown on the television 9. In this way the application simulates the correct timeline for executing content relating to the drawn balls 44 as each ball 44 is drawn in the media broadcast 10. This gives the overall impression of playing along with the viewed media broadcast 10.

In the alternative embodiment of the invention, rather than forwarding an event signal such as a data signal 62 that relates to a drawn ball 44 to the encoder 22 to be converted into a sub-audio signal 64, the event signal is broadcast via the cloud service.

Recorded versions of the media broadcast 10 signal will comprise a recorded version of the audio signal and therefore recorded versions of any sub-audio signals 64, 68. Therefore, provided that the viewer initialises the application 23 on the mobile communications device 4, the invention according to the first embodiment will operate normally because it will simply detect and act on the sub-audio signals 64 containing the numbers of the drawn balls 44.

If the viewer initialises the application 23 on the mobile communications device 4 and watches a recorded version of the lottery draw in accordance with the alternative embodiment of the invention, the application 23 will detect a sub-audio alert signal 68 that relates to a draw that has taken place. The application 23 then notifies the server 14 of the details of the draw being watched, via the data connection 70. On receipt of the notification, the server 14 broadcasts modified data signals 72 relating to the balls 44 drawn in the in the recording of the media broadcast 10. Accordingly, the application 23 delays executing content relating to the drawn balls 44 until the respective ball 44 is drawn in the media broadcast shown on the television 9.

In this instance, because the draw has happened, the time sequence triggered for the start of the draw will trigger the application 23 on the mobile communications device 4 to download the modified data signals 72, which are stored in the database 16, via the back office systems 30 with the appropriate time references. This enables content to be executed on the mobile communications device 4 in sync with the recorded version of the media broadcast 10 viewed on the television 9. The invention thereby enables a lottery operator to provide a simulated draw show experience for players who are unable to watch a broadcast show live on the television 9 and want to have the same experience on a recorded copy of the media broadcast 10 at a later date.

A further advantage of the invention in the arena of lottery draws is that the lottery draw details are immediately available to the lottery player's mobile communications device 4. This means that the mobile communications device 4 may automatically check the player's lottery numbers to confirm whether they are a winner. The mobile communications device 4 may also check any on-line lottery tickets that the player may have on an online account. In this embodiment, the lottery player will have registered for these services and provided their permission during the downloading and instillation of the application 23 on the mobile communications device 4.

The invention also enables interactive lottery content that may be triggered by sub-audio or event codes to start up on the mobile communications device 4. Such content may initiate coupon sales for special offers, for example, when a sub-audio signal or event signal is received by the mobile communications device 4. Furthermore, the invention may be used to notify the lottery player of the latest time a player may enter a draw, or provide draw and jackpot reminders.

Event signals according to the invention may be used to trigger content not directly associated with the media broadcast. For example, a plurality of mobile communications device 4 users may register in a pre-broadcast event. During registration for the pre-broadcast event, further content relating to a “secret” draw is downloaded and stored in the media store 34 of the application 23 of every hundredth mobile communications device 4 which is used to sign up for the pre-broadcast event. The further content relating to the “secret” draw is associated with a further sub-audio signal. During the media broadcast 10, the further sub-audio code is transmitted with the media broadcast 10 which triggers the further content to be executed on the mobile communications devices 4 that downloaded it.

The further content may relate to providing the user of the mobile communications device 4 on which the further content has been executed with an additional bonus play or voucher for a lottery draw. The effect of the further content in this embodiment of the invention is that a group of mobile communications devices 4 within range of a further sub-audio signal would be triggered to provide their users with further bonus content.

In a further example, an event signal may trigger advertising content on the mobile communications device. This is an effective way to advertise products or services to a consumer which the consumer may be interested in.

It is clear to the skilled person that the embodiments of the invention described herein may be readily combined. For example, the application may be arranged to distinguish between a sub-audio ball number signal and a sub-audio data alert signal, and react accordingly.

The invention has been described above with reference to a television media broadcast received by a television. However, it will be clear to the skilled person that the invention may be used with other media broadcasts, for example, radio or Internet media broadcasts.

It will be clear to the skilled person that modifications may be made to the above described systems or methods without departing from the spirit and scope of the invention as set out in the following claims.

1. A method of coordinating content on a mobile communications device with a media broadcast, the method comprising:
detecting on a mobile communications device a sub-audio signal transmitted in a media broadcast;
receiving at the mobile communications device an event signal relating to an event in the media broadcast, wherein the event signal is provided with a time reference corresponding to the related event in the media broadcast; and
executing on the mobile communications device content relating to the event in the media broadcast, wherein execution of the content is controlled according to the time reference corresponding to the event in the media broadcast and the sub-audio signal.

2. (canceled)

3. The method according to claim 1, wherein the event signal contains information for identifying content relating to the event.

4. The method according to claim 3, wherein the information comprises a code.

5. The method according to claim 1, wherein upon receipt of the event signal the content relating to the event is executed on the mobile communications device according to the time reference.

6. The method according to claim 1, wherein the method comprises encoding a data signal relating to the event into the sub-audio signal.

7. The method according to claim 1, wherein the sub-audio signal relates to an event in the media broadcast.
Just FYI I removed the rest of these.

8. The method according to claim 1, wherein the sub-audio signal comprises the event signal.

9. The method according to claim 1, wherein the time reference is provided by combining the sub-audio signal with the media broadcast at a point corresponding to the event.

10. The method according to claim 1, wherein the method comprises establishing a data connection between the mobile communications device and a server.

11. The method according to claim 10, wherein the data connection is initialised upon receipt of the sub-audio signal.

12. The method according to claim 10, wherein the event signal is transmitted over the data connection.

13. (canceled)

14. The method according to claim 10, wherein the event signal comprises a data signal transmitted via the data connection.

15. The method according to claim 1, wherein the time reference indicates when the content relating to the event is to be executed on the mobile communications device.

16. The method according to claim 1, wherein the time reference may be measured with reference to the sub-audio signal.

17. The method according to claim 1, wherein the time reference indicates how long after receipt of the sub audio-signal the content relating to the event is to be executed on the mobile communications device.

18. The method according to claim 1, wherein the method further comprises entering event information or data relating to the event into the mobile communications device.

19. (canceled)

20. The method according to claim 18, wherein the method comprises matching the event information or data with the event signal.

21. The method according to claim 18, wherein content is linked to the event information or data.

22. The method according to claim 1, wherein the method further comprises downloading content and/or event signals relating to the event to the mobile communications device.

23. The method according to claim 1, wherein the method further comprises:
receiving at least one additional event signal at the mobile communications device, wherein each of the at least one additional event signals relates to an additional event in the media broadcast, and each of the at least one additional event signals has a time reference in relation to the additional event; and
executing content relating to the at least one additional event on the mobile communications device according to each time reference of the at least one additional event.

24. An application for coordinating content executed on a mobile communications device with a media broadcast, the application comprising:
an analysis module for analysing the audio component of a media broadcast for a sub-audio signal;
a communications module arranged to receive an event signal relating to an event in the media broadcast, wherein the event signal has a time reference that relates to the event;
a store of content relating to events in the media broadcast, wherein the application is arranged to execute content relating to the event in the media broadcast in accordance with the time reference and the sub-audio signal.

25. The application according to claim 24, wherein the application is arranged to coordinate the audio and/or visual output of the mobile communications device with events occurring in the media broadcast.

26. The application according to claim 24, wherein the application is arranged to trigger at least one function or action on a mobile communications device relating to the content upon detection of the event signal relating to the event.

27. (canceled)

28. (canceled)

29. The application according to claim 24, wherein the application further comprises a controller for executing the content on a mobile communications device on receipt of the event signal.

30. (canceled)

31. The application according to claim 24, wherein the application comprises an interface for manually entering information or data relating to the event, wherein the application is arranged to match the manually entered information or data on receipt of the event signal.

32. (canceled)

33. A system for coordinating content on a mobile communications device with a media broadcast, the system comprising:
a server for processing an event signal relating to an event in the media broadcast; and
an encoder for combining a sub-audio signal with a media broadcast to form a combined signal;
wherein the system is arranged to add a time reference to the event signal corresponding to the related event in the media broadcast.

34. The system according to claim 33, wherein the system comprises receiving apparatus arranged to receive the combined signal, the receiving apparatus comprising a speaker to generate the audio portion of the combined signal.

35. (canceled)

36. (canceled)

37. The system of claim 33, wherein the encoder converts the event signal into the sub-audio signal.

38. (canceled)

39. The system according to claim 33, wherein the system further comprises a mobile communications device arranged to coordinate its audio and/or visual output with the media broadcast on detection of the sub-audio signal.

40. The system according to claim 39, wherein the mobile communications device comprises a software application arranged to analyse the audio portion of the combined signal for the sub-audio signal.

41. The system according to claim 39, wherein the mobile communications device further comprises content relating to the event, wherein the mobile communications device is arranged to execute the content in accordance with the time reference.

42. (canceled)

43. (canceled)

44. (canceled)

45. (canceled)
